(19) United States
(12) Patent Application Publication
(10) Pub. No.: US 2015/0211580 A1
(43) Pub. Date: Jul. 30, 2015

(54) BEARING POWER EMBEDDED GENERATING CONFIGURATION

(71) Applicant: AKTIEBOLAGET SKF, Göteborg (SE)

(72) Inventor: Andreas Clemens Van Der Ham, Utrecht (NL)

(21) Appl. No.: 14/395,120

(22) PCT Filed: Mar. 22, 2013
(86) PCT No.: PCT/EP2013/056048

§ 371 Date: Oct. 17, 2014

(30) Foreign Application Priority Data
Apr. 24, 2012 (EP) PCT/EP2012/057425

(51) Int. Cl. F16C 41/00; G01M 13/04; H02K 7/18

(52) U.S. Cl. CPC F16C 41/004; H02K 7/1846; G01M 13/04

(57) ABSTRACT

A power generating bearing assembly comprising a power generating subassembly integrated into a bearing. The power generating subassembly utilizes the relative motion between a bearing inner ring and a bearing outer ring of the bearing to generate electrical power. A sealing member is attached to one of the bearings at one end thereof. The power generating subassembly includes an electrical generator assembled through an aperture of the sealing member within an interior section of the bearing and positioned to be in operational engagement with a magnetically polarized material. The magnetically polarized material is integrated into a magnetic ring, which is attached to the non-seal carrying bearing ring. The relative motion between the rings engages the electrical generator and the magnetically polarized material causing a generator core of the electrical generator to create an electrical current.

### CROSS REFERENCE TO RELATED APPLICATIONS

This is a National Stage application claiming the benefit of International Application Number PCT/EP2013/056048 filed on 22 Mar. 2013, which claims the benefit of International Application Number PCT/EP2012/057425 filed on 24 Apr. 2012, both of which are incorporated herein by reference in their entireties.

### TECHNICAL FIELD OF THE INVENTION

The present invention relates to an apparatus and method for generating power during motion of a bearing.

### BACKGROUND

A bearing can be defined as any of various machine elements that constrain the relative motion between two or more parts to only the desired type of motion. This is typically to allow and promote free rotation about a longitudinal axis and/or restrain any linear movement of a component in a normal direction respective to the bearing. Bearings may be classified broadly according to the motions they allow and according to their principle of operation, as well as by the directions of applied loads they can handle.

Bearings undergo significant use, which causes wear to the various bearing components. Over time, the wear on the bearing can result in mechanical failure. Mechanical failure can impact the rotational motion and/or the axial linear restraint. Failure to control either of these movements can cause catastrophic failure to the machinery relying upon the bearing.

Bearing reliability and predictive servicing can impact the operation and uptime of equipment. Bearings are used in many applications, including vehicles, wind turbines, automated machinery, and the like. Over time, the bearings wear. Bearing failure during operation can cause significant damage to the equipment and possibly the surrounding area. The bearing failure could even potentially cause injury or death to people should the right circumstances come occur.

Bearing monitoring systems require power for operation. Power is utilized for operating the condition monitoring sensors, providing power for any computing devices, and providing power for transferring any collected information to a centralized system. The power is provided through wiring to the devises.

Bearing reliability and predictive servicing can be improved by monitoring the bearing. A monitoring system would require power. What is desired is a power generating system associated with the bearing assembly.

### SUMMARY OF THE INVENTION

The present invention is directed towards an apparatus and respective method for generating electrical energy during the operation of equipment comprising a bearing.

In a first aspect of the present invention, a power generating bearing assembly, the power generating bearing assembly comprising:

a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein the bearing engaging outer surface is sized to rotationally engage with said outer ring bearing engaging inner surface,
a sealing system comprising a sealing system member assembled between the bearing outer ring and the bearing inner ring at one of the end surfaces, of the bearing sealing a gap therebetween,
at least one sensor receiving aperture provided through sealing system member,
a magnetic wheel concentrically located respective to the bearing and secured to a magnetic wheel drive ring, wherein the magnetic wheel drive ring is one of the bearing outer ring and the bearing inner ring and the remaining ring, is a respective rotational ring, the magnetic wheel comprising a magnetically polarized material supporting flange carrying a magnetically polarized material, the magnetically polarized material supporting member provided as a unitary section of the sealing system extending axially away from the ring end surfaces, wherein the magnetically polarized material is positioned proximate the at least one sensor receiving aperture,
wherein said inner ring is rotationally assembled within said outer ring bearing engaging inner surface; and

an electrical power generator including a generator core, the generator core comprising an electrical coil wound about a magnetic core to generate electrical power, the electrical power generator being attached to the sealing system member directing the generator core in a radial direction to operationally engage with the magnetically polarized material;

wherein the relative motion between the bearing outer ring and the bearing inner ring passes the magnetically polarized material across the generator core causing the generator core to create an electrical current.

In a second aspect, the system further includes a processing device comprising a set of digital instructions for monitoring and analyzing digital data provided by a condition monitoring system integrated into the bearing assembly.

In another aspect, the magnetically polarized material is provided having a height greater than a predetermined anticipated axial motion of the generator core.

In another aspect, the magnetically polarized material can be provided in a complete annular ring; in a single section covering a partial circularly shaped section; or in a series of sections which are spatially at equal radial distances from a bearing ring center.

One advantage of the present invention is the ability to generate a continued electrical current during motion of one of the rings of the bearing. The power can be utilized to operate bearing condition monitored equipment. The inclusion of an electrical power-generating device eliminates any need for a locally stored power (such as by a battery) or conveyed power from an external power source. By generating power at the location, the system can operate completely independent and un-tethered from any other device by providing sufficient power for wireless signal communications. While yet another advantage is that operation of the monitoring system can be limited to the time where the bearing is undergoing rotation. Power is only applied to the system when the generator is subjected to the relative motion between the bearing outer ring and the bearing inner ring.

Bearings can be utilized on equipment deployed in remote locations. The location could complicate any provisions for externally provided power for monitoring the condition of the bearing. The bearing(s) can be integrated into the equipment at a location that is difficult to access, particularly for wiring. Further, wires can accidentally interfere or become abraded by any rotational movements or other movements of components of the equipment.

Another advantage locates the magnetically operative generator core within a sealed portion of the bearing, thus avoiding any impact from contaminants. Magnetic power generating equipment is susceptible to attraction to, collection of, and subsequent damage from magnetic particles. The particles would collect between the magnetically operative generator core and the magnetically polarized material. As the bearing rotates, the contaminants could abrade the surfaces of the magnetically operative generator core and/or the magnetically polarized material

The use of a magnetic density operated generator core eliminates any wear and reliability issues associated with moving components. The axial relation between the magnetically polarized material supporting member and the electrical power generator can be a frictional interface or an air gap. The preferred embodiment utilizes an air gap. Any contacting surfaces can include bearings, friction reduced surfaces, and the like to minimize any impact resulting from relative motion between two moving components contacting one another.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents an exemplary schematic diagram of a bearing power generator and bearing condition monitoring system;

FIG. 2 presents a top view of an exemplary power generating bearing assembly;

FIG. 3 presents a sectioned side view of the exemplary power generating bearing assembly originally introduced in FIG. 2, the section taken along section line 3-3 of FIG. 2;

FIG. 4 presents a magnified section of the power generating subassembly installed in the bearing;

FIG. 5 presents a top view of the power generating subassembly;

FIG. 6 presents a partial sectioned side view of the power generating subassembly of FIG. 5;

FIG. 7 presents a partial sectioned side view of the power generating subassembly, the section taken along section line 7-7 of FIG. 6; and

FIG. 8 presents a sectioned top view illustrated the relation between the power generating subassembly and the magnetic wheel.

Like reference numerals refer to like parts throughout the several views of the drawings.

### DETAILED DESCRIPTION OF THE PRESENT INVENTION

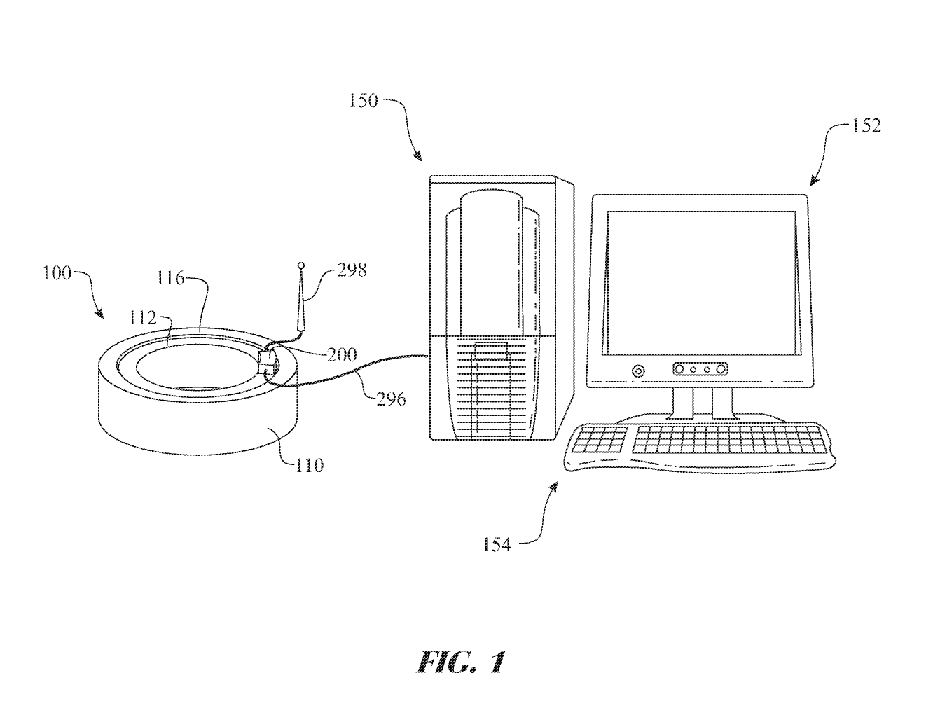

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A generic exemplary system schematic is presented in FIG. 1. The generic system includes a power generating bearing assembly 100 comprising a power generating subassembly 200 integrated into bearing 110. The bearing 110 is fabricated having a bearing inner ring 112 assembled within a bearing outer ring 116, wherein the interface between the bearing inner ring 112 and the bearing outer ring 116 restrains the relative motion to a rotational motion about a central axis. The relative rotational motion provided between the bearing inner ring 112 and the bearing outer ring 116 causes the power generating subassembly 200 to generate electrical energy in a form of an electrical current. The power generating subassembly 200 can include a sensor, a digital signal processor or any other device to embed a digital data signal within a current. The digital data signal is transmitted to a processing unit 150 via a wired signal interface 296 or preferably via a wireless signal interface 298. The wireless signal interface 298 includes circuitry and components respective to any selected wireless transmitting protocol. Power would be provided by the power generating subassembly 200 to operate the wireless signal interface 298.

The processing device 150 includes common digital data processing components, include a motherboard, at least one microprocessor, memory, a data recording device, digital instructions (such as software, firmware, and the like), input/output controllers, data communication devices, and the like. A user input device 154 and a user output device 152 are connected in signal communication to the processing device 150 through the input/output controllers. The digital data signal is received by the processing unit 150 and interpreted accordingly. The digital data signal would be provided when the power generating bearing assembly 100 is subjected to movement. The relative movement between the bearing inner ring 112 and the bearing outer ring 116 causes the power generating subassembly 200 to generate electrical power. Therefore, the electrical power is only available when the bearing inner ring 112 and bearing outer ring 116 are in relative motion to one another. It is understood that electrical power can be stored in a capacitor or battery integrated within the power generating subassembly 200. This would enable short cycles of additional power for continued operation after the bearing inner ring 112 and bearing outer ring 116 become stationary respective to one another. This would be beneficial for recording conditions of the bearing 110 after halting any operation, during cool down, and the like. The system can be recording conditions such as temperature, and the like.

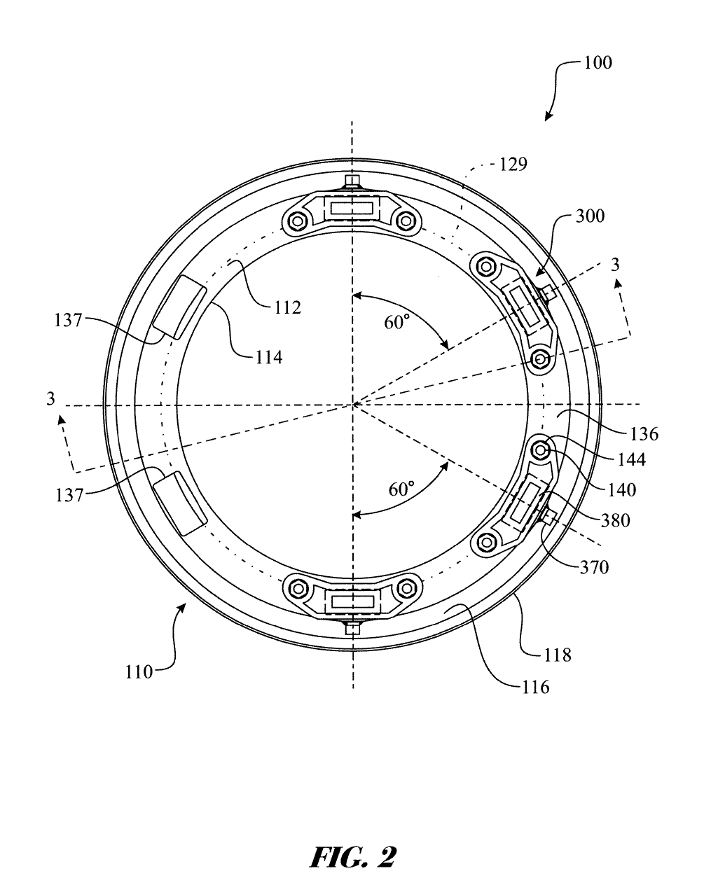

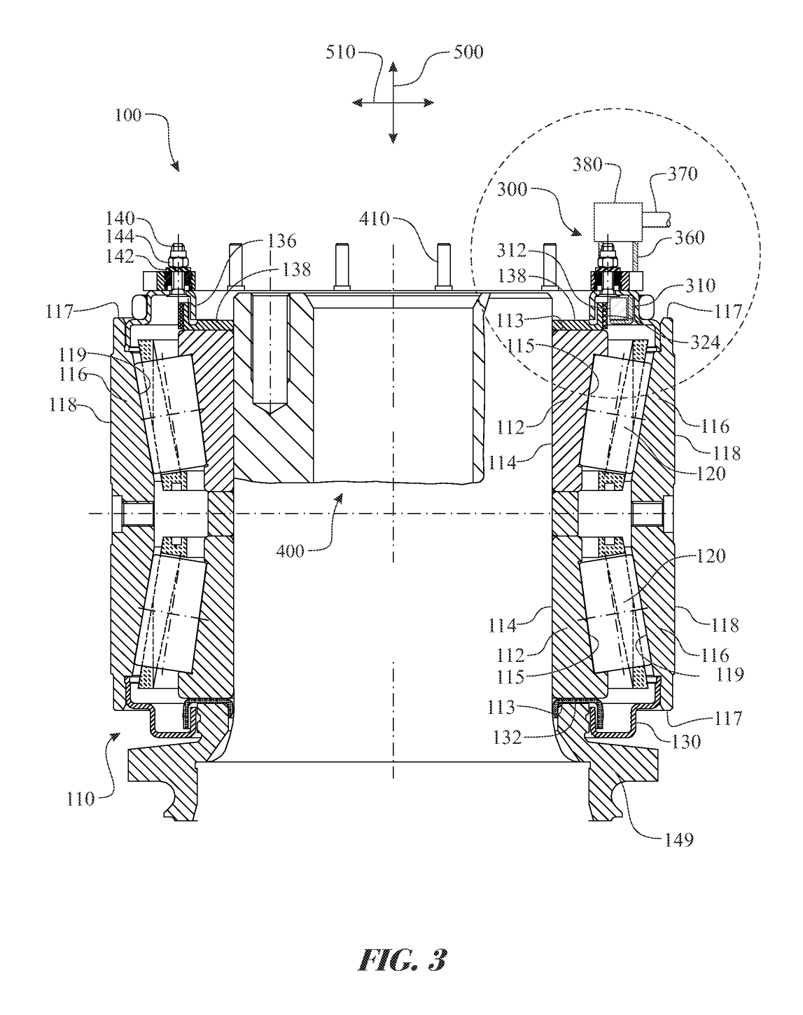

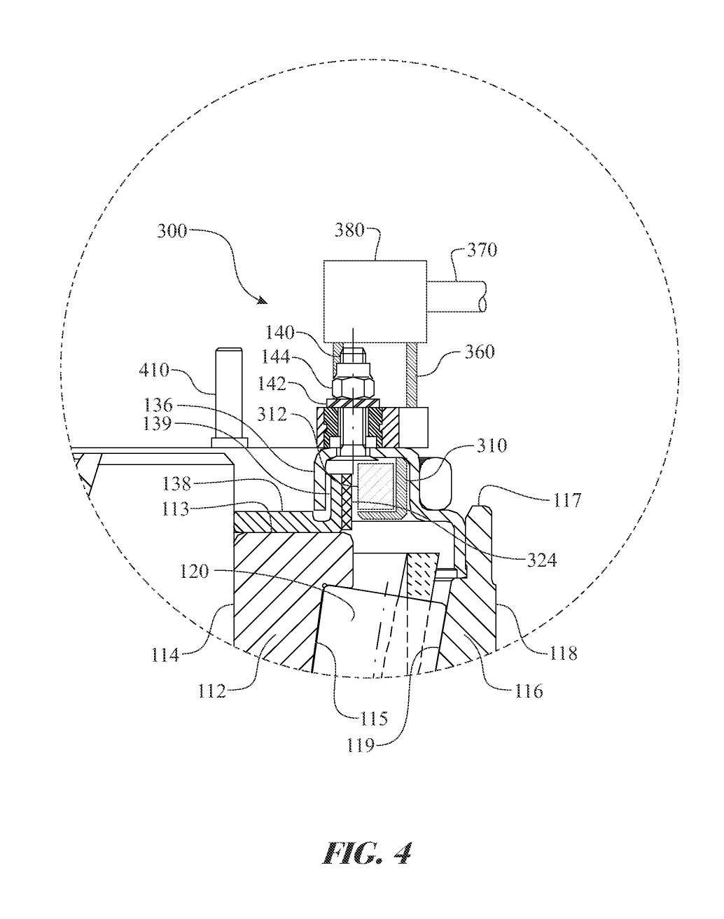

An exemplary embodiment of the power generating subassembly 200 is presented as a power generating subassembly 300 illustrated in FIGS. 2 through 4. The directional lines illustrated in FIG. 3 represent orientation references. An axial direction 500 is parallel to the axis or rotation of the bearing rings 112, 116. A radial direction 510 is parallel to a radius of the bearing rings 112, 116. The illustrations present additional details of the bearing 110. Features of the bearing inner ring 112 can be referred to as: a bearing assembly component engagement surface 114 defining an inner peripheral surface thereof; a bearing outer race engaging surface 115 defining an outer peripheral surface thereof; and an inner ring end surface 113 defining an end surface thereof. Features of the bearing outer ring 116 can be referred to as: a bearing outer surface 118 defining an outer peripheral surface thereof; a bearing outer race engaging surface 119 defining an inner peripheral surface thereof; and an outer ring end surface 117 defining an end surface thereof. At least one bearing race set 120 can be assembled between the bearing inner ring 112 and bearing outer ring 116. The exemplary embodiment includes a pair of race sets 120. The bearing race set 120 can be selected from any configuration known by those skilled in the art.

A sealing system is provided at each end of the bearing 110. The sealing system provides a seal across the gap formed between the bearing inner ring 112 and the bearing outer ring 116. The sealing system is integrated into the bearing 110 to avoid entry of contaminants into the region of the bearing 110 comprising the bearing race set 120. The sealing system can be attached to one of the bearing rings 112, 116 and float against the remaining bearing 116, 112. The bearing that retains the sealing system 130 can be referred to as a sealing attachment bearing ring. The remaining ring is a respective rotational bearing ring.

The exemplary embodiment utilizes an outer seal ring 130 in combination with an internal z-labyrinth 132 is integrated into a first end of the bearing 110 to provide a first seal thereto. An external z-labyrinth 136 is attached to the bearing outer surface 118 at an opposite end of the bearing 110 to provide a second seal thereto. A magnetic wheel 138 is carried the bearing inner ring 112 and designed to engage with the external z-labyrinth 136 forming the seal upon the bearing end. A backing ring 149 is secured to a non-generating end of the bearing 110.

The magnetic wheel 138 includes an axially arranged segment 139 extending from a radially distal end of the magnetic wheel 138, preferably at a right angle and directed axially outward. A magnetically polarized material 324 is carried by the axially arranged segment 139.

A rotating mount assembly 400 is inserted into a center of the bearing 110, which is defined by the bearing assembly component engagement surface 114. The bearing 110 is preferably pressed onto an exterior surface of the rotating mount assembly 400. A plurality of mounting fasteners 410 can be inserted into an assembly end of the rotating mount assembly 400. The plurality of mounting fasteners 410 provides a mounting interface for securing a component to the system.

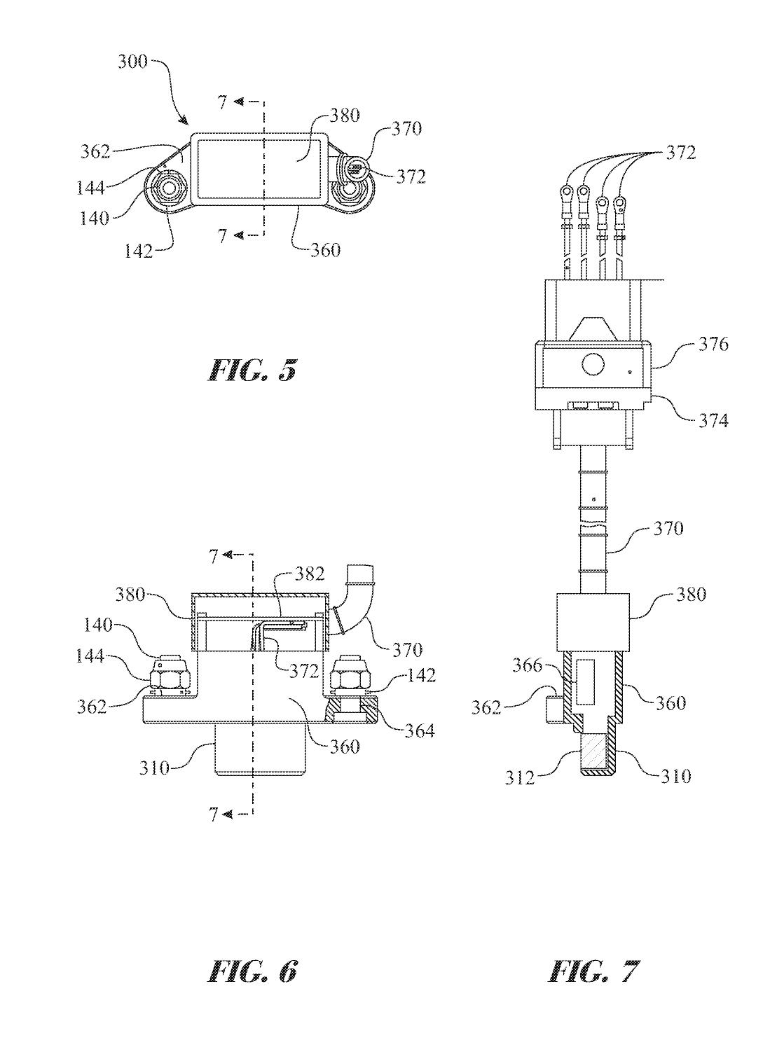

An electrical power generator 310 is included as a component of the power generating subassembly 300. Details of the power generating subassembly 300 are provided in FIGS. 5 through 7. A generator core 312 is carried by the electrical power generator 310. The generator core 312 comprises an electrical coil 316 wound about a magnetic core 318. The electrical power generator 310 is assembled to the respective rotational ring orienting the generator core 312 in a radial direction to operationally engage with the magnetically polarized material 324. A negative temperature coefficient (NTC) thermistor can be embedded within the electrical power generator 310 to monitor the temperature of the bearing 110.

The electrical power generator 310 extends downward from a sensor body 360. The sensor body 360 is formed to provide a mounting structure for the components contained therein, to provide protection for components stored therein, and retain structural integrity of the power generating subassembly 300. At least one sensor body mounting flange 362 is extends outward from the sensor body 360. The sensor body mounting flange 362 is preferably formed as a unitary element of the sensor body 360, wherein the unitary features are all formed simultaneously during the fabrication process. A fastener receiving aperture 364 is formed through the sensor body mounting flange 362 to receive a threaded mounting fastener 140. The outer portion of the sensor body mounting flange 362 is preferably sized and shaped to receive and support a washer 142 and a respective nut 144. A port may be formed through a wall of the sensor body 360 for passage of an electrical conduit. An electronics enclosure 380 can be formed separately and attached to or formed as a unitary segment of the sensor body 360. The electronics enclosure 380 houses any additional electronics, such as a printed circuit assembly 382, and the like. The printed circuit assembly 382 can provide any of a multitude of functions, including current and/or voltage regulation, condition monitoring functions, and the like. The sensor body 360 or electronics enclosure 380 can additionally include an accelerometer 366. The accelerometer can provide acceleration and velocity information respective to operation of the bearing 110.

The generator core 312 is provided in electrical communication with other electrical components via a series of electrical conductors 372. The electrical conductors 372 can provide electrical communication to the printed circuit assembly 382, directly to other components, and the like. At least a portion of the series of electrical conductors 372 is routed through an electrical conductor boot 370. The electrical conductor boot 370 provides protection to the electrical conductors 372 from wear, heat, abrasion, and the like during operation the bearing 110. The electrical conductor boot 370 also protects the electrical conductors 372 from the elements and accelerated corrosion. A first connector section 374 is integrated at the free end of the electrical conductor boot 370 for electrical engagement with other external components. A second connector section 376 is designed to mechanically and electrically mate with the first connector section 374. The second connector section 376 is provided for assembly to a mating end of the electrical cabling of external components. The first connector section 374 and second connector section 376 form a connector junction.

One or more sensor receiving apertures 137 are provided through the external z-labyrinth 136 for passing the electrical power generator 310 therethrough. Each power generating subassembly 300 is assembled to the external z-labyrinth 136 by a pair of threaded mounting fasteners 140. The power generating subassembly 300 is assembled to the external z-labyrinth 136 by inserting the electrical power generator 310 into the sensor receiving aperture 137. The power generating subassembly 300 is oriented positioning the generator core 312 proximate the magnetically polarized material 324. An optional sealing gasket (not shown, but well understood by description) can be provided between contacting surfaces of the external z-labyrinth 136 and the sensor body 360 to provide a suitable seal therebetween. It is understood that the threaded mounting fastener 140 can be assembled to the external z-labyrinth 136 using any stud attachment method. In the exemplary embodiment, each threaded mounting fastener 140 is inserted from an interior side of the external z-labyrinth 136, extending outward therefrom. A head of the threaded mounting fastener 140 embeds itself into the interior surface restraining the threaded mounting fastener 140 from any rotation. The power generating subassembly 300 is placed onto the external z-labyrinth 136, passing each threaded mounting fastener 140 through the respective aperture provided through the sensor body mounting flange 362. A washer 142 is a placed over the threaded mounting fastener 140. The washer 142 is preferably an elastic washer. It is understood that the washer 142 can be any form of a washer, including an integrated washer, a locking washer, a flat washer, and the like, and fabricated of any suitable material, including brass, stainless steel, nylon, anodized steel, and the like. A nut 144 is threaded onto the threaded mounting fastener 140 and tightened to a predetermined torque. It is preferred that the nut 144 is a self-locking nut. It is understood that the nut 144 can be any other suitable nut, including a hex nut, a wing nut, and the like, and fabricated of any suitable material, including stainless steel, anodized steel, brass, and the like.

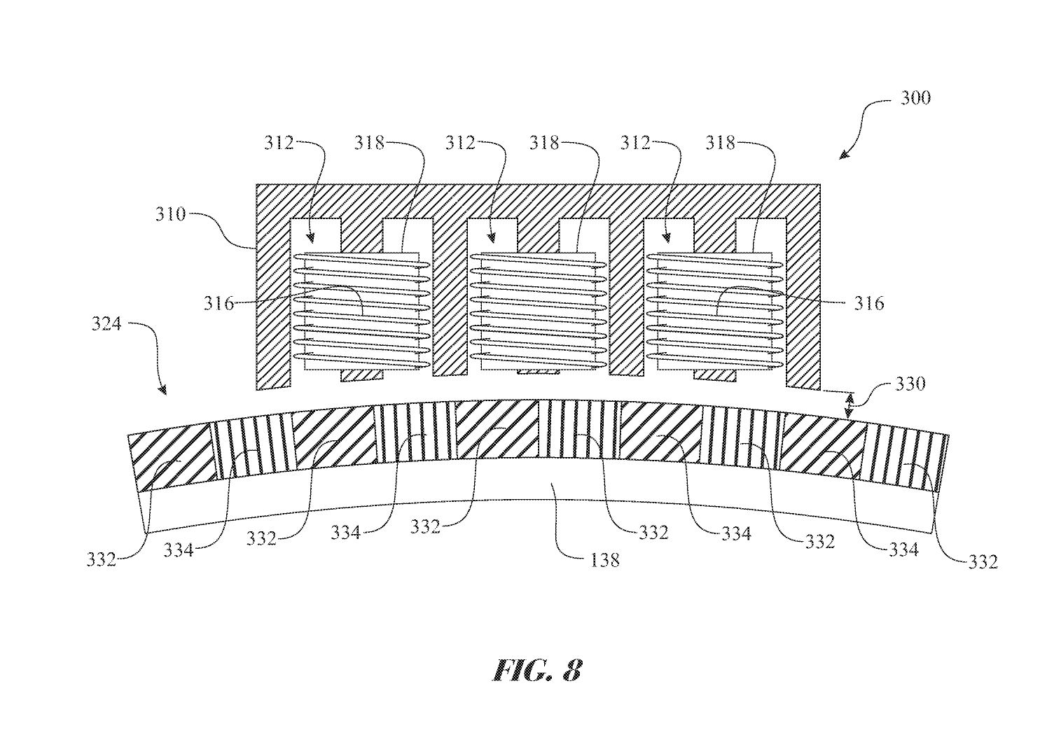

Operation of the power generating subassembly 300 is best represented in FIG. 8. In operation, as the bearing inner ring 112 and bearing outer ring 116 rotate respective to one another, the generator core 312 passes across the magnetically polarized material 324. The magnetically polarized material 324 includes variations in magnetic properties, as represented by a first magnetic state 332 and a second magnetic state 334. The first magnetic state 332 and second magnetic state 334 can be arranged with opposite polarities, where the first magnetic state 332 is magnetic and the second magnetic state 334 is non-magnetic, or with any differing magnetic properties to cause a change in the magnetic flux of the magnetic core 318. As the magnetically polarized material 324 moves relative to the generator core 312, the variations in magnetic properties of the magnetically polarized material 324 changes the magnetic flux of a magnetic core 318 integrated into the generator core 312. The change in magnetic flux creates an electrical current in an electrical coil 316 wrapped about the magnetic core 318. The electrical current is conveyed to other equipment by the series of electrical conductors 372. The power generating bearing assembly 100 positions an operational surface of the power generating subassembly 300 at a small distal relation from the mating operational surface of the magnetically polarized material 324. The small distance creates an air gap 330 therebetween. The desired air gap for one application would be 1.0 mm.

An optional circumferential gliding material can be attached to the electrical power generator 310, wherein the circumferential gliding material would be attached upon an arched surface which is radially parallel and proximate the magnetically polarized material 324. Alternatively, the circumferential gliding material can be attached to the magnetically polarized material 324, wherein the circumferential gliding material would be attached upon an arched surface which is radially parallel and proximate the electrical power generator 310.

The illustrated embodiment positions the generator core 312 facing inward towards the magnetically polarized material 324. It is understood that the generator core 312 can be facing outwards and the magnetically polarized material 324 would be located at a radial distance greater than the operational face of the generator core 312.

It is preferred that the external z-labyrinth 136 and subsequently each of the power generating subassembly 300 be attached to the bearing outer ring 116, wherein it is understood that the bearing outer ring 116 remains stationary. In a condition where the bearing inner ring 112 remains stationary, it would be desired that the external z-labyrinth 136 and subsequently each of the power generating subassembly 300 be attached to the bearing inner ring 112. These configurations are recommended to support the cabling. These limitations are not imposed for configurations utilizing wireless technology, where the entire configuration is isolated to the bearing 100.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### REF. NO. DESCRIPTION

100 power generating bearing assembly
110 bearing
112 bearing inner ring
113 inner ring end surface
114 bearing assembly component engagement surface
115 bearing outer race engaging surface
116 bearing outer ring
117 outer ring planar end surface
118 bearing outer surface
119 bearing outer race engaging surface
120 bearing race set
130 outer seal ring
132 internal z-labyrinth
136 external z-labyrinth
137 sensor receiving aperture
138 magnetic wheel
139 axially arranged segment
140 threaded mounting fastener
142 washer
144 nut
149 backing ring
150 processing unit
152 output device
154 user input device
200 power generating subassembly
296 wired signal interface
298 wireless signal interface
300 power generating subassembly
310 electrical power generator
312 generator core
316 electrical coil
318 magnetic core
324 magnetically polarized material
330 air gap
332 first magnetic state
334 second magnetic state
360 sensor body
362 sensor body mounting flange
364 fastener receiving aperture
366 accelerometer
370 electrical conductor boot
372 electrical conductors
374 first connector section
376 second connector section
380 electronics enclosure
382 printed circuit assembly
400 rotating mount assembly
410 mounting fasteners
500 axial direction
510 radial direction

1. A power generating bearing assembly, the power generating bearing assembly comprising:
a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein said bearing engaging outer surface is sized to rotationally engage with said outer ring bearing engaging inner surface,
a sealing system comprising a sealing system member assembled between said bearing outer ring and said bearing inner ring at one of said end surfaces of said bearing sealing a gap therebetween,
a magnetic wheel concentrically located respective to said bearing and secured to a magnetic wheel drive ring, wherein said magnetic wheel drive ring is one of said bearing outer ring and said bearing inner ring and said remaining ring is a respective rotational ring,
wherein said inner ring is rotationally assembled within said outer ring bearing engaging inner surface; and
an electrical power generator including a generator core, said generator core comprising an electrical coil wound about a magnetic core to generate electrical power, said electrical power generator being attached to said sealing system member;
wherein said relative motion between said bearing outer ring and said bearing inner ring passes said magnetically polarized material across said generator core causing said generator core to create an electrical current,
said sealing system member directing said generator core in a radial direction to operationally engage with said magnetically polarized material,
at least one sensor receiving aperture provided through said sealing system member for passing the electrical power generator therethrough,
said magnetic wheel comprising a magnetically polarized material supporting flange carrying a magnetically polarized material, said magnetically polarized material supporting flange provided led as a unitary section of said sealing system extending axially away from said ring end surfaces, wherein said magnetically polarized material is positioned proximate said at least one sensor receiving aperture, thus positioning said generator core proximate said magnetically polarized material.

2. A power generating bearing assembly according to claim 1, said at least one sensor receiving aperture (137) comprising a plurality of sensor receiving apertures equidistantly spaced and concentrically positioned about said sealing system member.

3. A power generating bearing assembly according to claim 1, further comprising a printed circuit assembly integrated within said electrical power generator.

4. A power generating bearing assembly as recited in according to claim 1, further comprising an accelerometer integrated within said electrical power generator.

5. A power generating bearing assembly according to claim 1, further comprising at least one bearing race set located between said bearing outer race engaging surface and said outer ring bearing engaging inner surface.

6. A power generating bearing assembly according to claim 5, further comprising a pair of bearing race sets located between said bearing outer race engaging surface and said outer ring bearing engaging inner surface, wherein the bearing sets are angled to provide both rotational stability and axial stability to a rotating mount assembly affixed to the bearing assembly component engagement surface.

7. A power generating bearing assembly according to claim 1, wherein said electrical power generator is positioned respective to the magnetically polarized material forming an air gap therebetween.

8. A power generating bearing assembly according to claim 1, wherein the
the sealing system member is assembled to said bearing outer ring at one of said end surfaces of said bearing, the sealing system member sealing a gap between the bearing outer ring and the bearing inner ring,
the magnetic wheel being concentrically located respective to said bearing and secured to said bearing inner ring.

9-13. (canceled)

14. A power generating bearing assembly according to claim 1, wherein
said electrical power generator being positioned respective to the magnetically polarized material forming an air gap therebetween.

15-19. (canceled)

20. A power generating bearing assembly according to any of the preceding claims, wherein the sealing system member (136) constitutes an external z-labyrinth.
